(19) United States
(12) Patent Application Publication
(10) Pub. No.: US 2011/0117832 A1
(43) Pub. Date: May 19, 2011

(54) AIR CONDUCTING DEVICE

(75) Inventors: XIAN-XIU TANG, Shenzhen City (CN); ZHEN-XING YE, Shenzhen City (CN); CHIA-SHIN CHOU, Tu-Cheng (TW)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/763,187

(22) Filed: Apr. 19, 2010

(30) Foreign Application Priority Data
Nov. 19, 2009 (CN) 200910309935.7

(51) Int. Cl. F24F 7/007; F16L 9/00

(52) U.S. Cl. 454/338; 138/177

(57) ABSTRACT

An air conducting device includes an air-guiding unit, and a fan. The air-guiding unit includes a fixing member and a conducting member slidably mounted to the fixing member. The fixing member defines a number of slots arranged in a line, and a through passage. The conducting member defines a through hole communicating with the through passage. A locking protrusion protrudes from the conducting member, and the locking protrusion is adjustably engaged in one of the number of slots. The fan is fixed in the through passage of the fixing member, opposite to the conducting member.

### BACKGROUND

1. Technical Field

The present disclosure relates to air conducting devices, and particularly to an air conducting device in a computer.

2. Description of Related Art

Electronic devices, such as computers, use heat dissipation assemblies for dissipating heat generated by components therein, thus preventing the components from becoming overheated. A conducting device is often used in a computer with a fan to assist in heat dissipation. The conducting device includes an airduct covering the heat generating components of the computer, and a fan installed at or near the inlet of the airduct to generate airflow to dissipate heat from the heat generating components covered by the airduct. However, a conventional airduct has a non-variant length, any changes in the heat generating components configuration necessitate changes in the airduct, which is tedious, time-consuming, and costly.

### BRIEF DESCRIPTION OF THE DRAWINGS

FIG. 1 is an exploded, isometric view of an exemplary embodiment of an air conducting device.

FIG. 2 is an inverted view of the air conducting device of FIG. 1.

FIG. 3 is an assembled view of the air conducting device of FIG. 1.

FIG. 4 is an assembled view of the air conducting device of FIG. 2.

FIG. 5 is similar to FIG. 4, but showing another usage state of the air conducting device.

### DETAILED DESCRIPTION

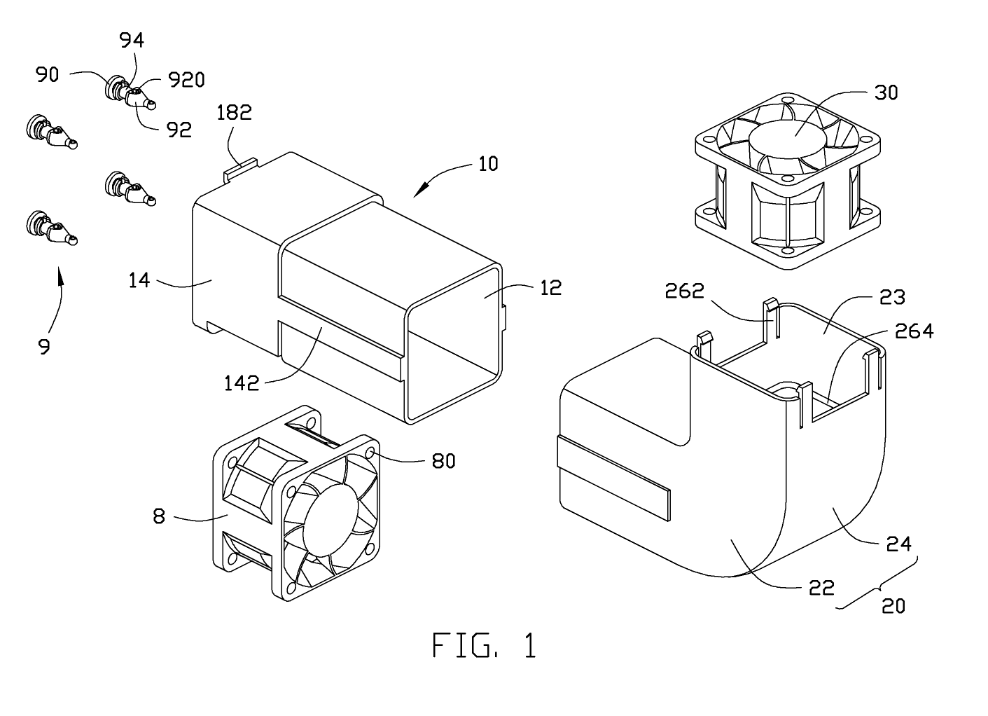

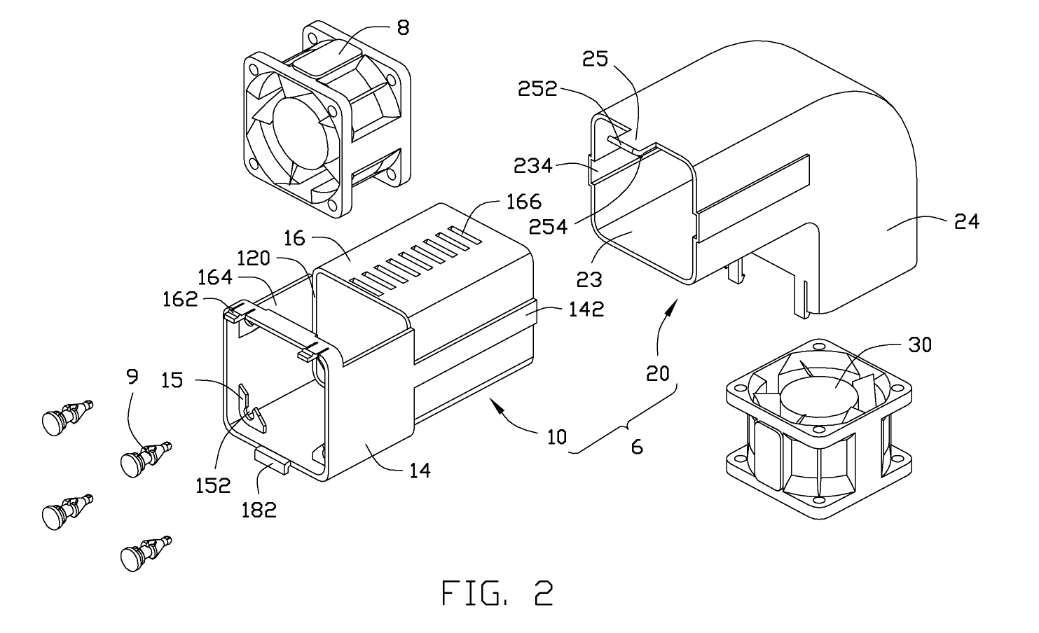

Referring to FIGS. 1 and 2, in an exemplary embodiment, an air conducting device is configured to assist in the removal of heat from inside a device such as a computer. The air conducting device includes an air-guiding unit 6, a first fan 8 and a second fan 30 mounted to opposite ends of the air-guiding unit 6, and four fasteners 9 used to fix the first fan 8 to the air-guiding member 6.

Four through holes 80 are respectively defined in corners of the first fan 8. The second fan 30 is similar to the first fan 8.

Each fastener 9 is made of elastic material, such as elastomer, plastic, or rubber. Each fastener 9 includes a head portion 90, a taper shaped engaging portion 92, and a neck portion 94 between the head portion 90 and the engaging portion 92. The engaging portion 92 defines a cutout 920 for allowing deformation of the engaging portion 92. In another embodiment, the fasteners 9 are bolts.

The air-guiding unit 6 includes a hollow fixing member 10 and a conducting member 20 slidably mounted to the fixing member 10.

The fixing member 10 includes a larger receiving portion 14 and a smaller locking portion 16 integrally extending from the receiving portion 14. The fixing member 10 defines a stepped through passage 12 in a center of the fixing member 10, longitudinally extending through the receiving portion 14 and the locking portion 16. A circular stopping surface 120 is formed on an inner sidewall bounding the through passage 12, at a joint of the receiving portion 14 and the locking portion 16. Four fixing blocks 15 in the through passage 12 extend inwards from corners of the receiving portion 14, away from the stopping surface 120. Each fixing block 15 defines a mounting hole 152 for the corresponding fastener 9 extending therethrough. A top sidewall of the receiving portion 14 defines an opening 164 communicating with the through passage 12. Two hooks 162 extend from a front edge of the top sidewall of the receiving portion 14 opposite to the locking portion 16. A tab 182 extends downward from a front edge of a bottom of the receiving portion 14.

A top sidewall of the locking portion 16 defines a plurality of slots 166 arranged in a line. Two sliding blocks 142 protrude from outer surfaces of opposite sidewalls of the locking portion 16, extending longitudinally to connect to the receiving portion 14.

The conducting member 20 is substantially L-shaped and includes a connecting portion 22, and a guiding portion 24 slantingly connected to the connecting portion 22. The conducing member 20 defines a through hole 23 in a center of the conducting member 20, extending through the connecting portion 22 and the guiding portion 24, for allowing air flow therethrough. Inner surfaces of opposite sidewalls bounding the through hole 23 of the connecting portion 22 each define a sliding rail 234 longitudinally extending to the guiding portion 24. A latching portion 25 extends from a front edge of a top sidewall of the connecting portion 22, away from the guiding portion 24. A distal end of the latching portion 25 extends upwards to form an operating portion 252, and a locking protrusion 254 protrudes downward from the latching portion 25. Four elastic fixing hooks 262 extend from opposite ends of the guiding portion 24, and a stepped supporting surface 264 is formed on an inner sidewall bounding the through hole 23, and is located at the guiding portion 24 to support the second fan 30 in the through hole 23.

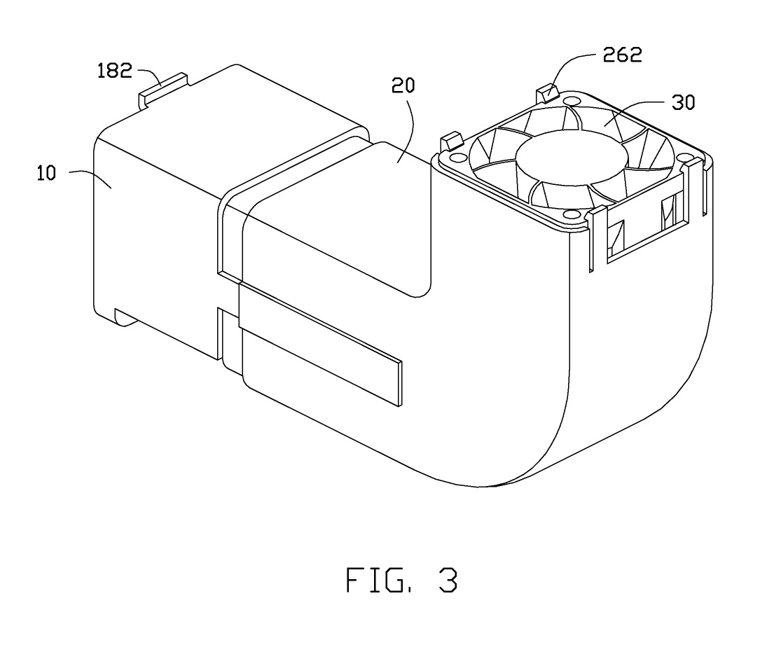

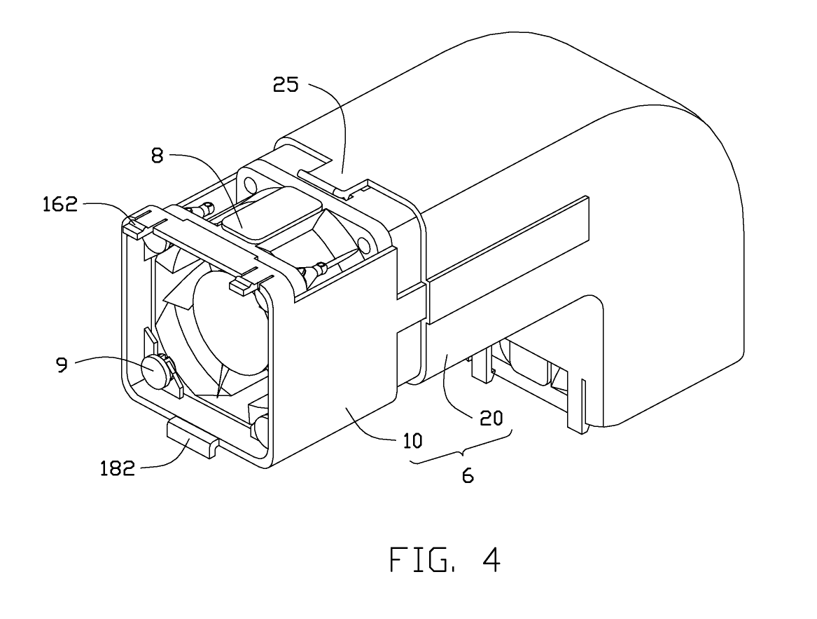

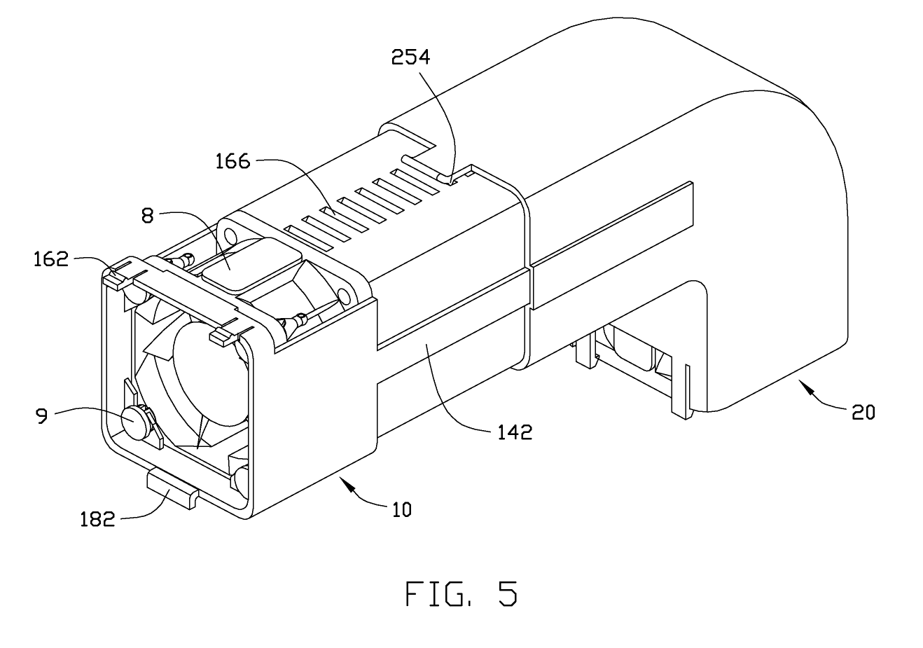

Referring to FIGS. 3 to 5, in assembly, the first fan 8 is placed in the receiving portion 14 through the opening 164, to be received in the through passage 12 of the fixing member 10. Opposite sides of the first fan 8 resist against the fixing blocks 15 of the fixing member 10 and the stopping surface 120 of the fixing member 10, with the through holes 80 of the first fan 8 aligning with the mounting holes 152 of the fixing blocks 15. The engaging portions 92 of the fasteners 9 are urged to extend through the mounting holes 152 and the through holes 80 in that order, and then the engaging portions 92 are released after passing through the through holes 80 of the first fan 8, thereby, the first fan 8 is fixed to the fixing member 10. The locking portion 16 of the fixing member 10 is inserted into the through hole 23 of the conducting member 20 of the air-guiding unit 6, with the sliding blocks 142 of the locking portion 16 slidably engaging in the sliding rails 234 of the conducting member 20, respectively. The through passage 12 of the fixing member 10 communicates with the through hole 23 of the conducting member 20. The locking protrusion 254 of the conducting member 20 is adjustably engaged in one of the slots 166 of the locking portion 16. The second fan 30 is received in the guiding portion 24 of the conducting member 20, with opposite sides of the second fan 30 resisting against the supporting surface 264 of the conducting member 20 and the fixing hooks 262 of the conducting member 20. Thereby, the second fan 30 is fixed in the through hole 23.

In use, the hooks 162 and the tab 182 of the fixing member 10 of the air-guiding unit 6 can be fixed to a motherboard having a first heat generating component (not shown), such as a hard disk drive, with the first fan 8 facing the first heat generating component. The conducting member 20 of the air-guiding unit 6 is adjustably fixed to the fixing member 10, via the locking protrusion 254 of the conducting member 20 selectively engaging in one of the slots 166 of the locking portion 16, to assure alignment of the guiding portion 24 of the conducting member 20 and the second fan 30 with a second heat generating component (not shown) of the motherboard, such as a central processing unit, generating more heat than the first heat generating component. Thereafter, the first and second fans 8, and 30 are turned on to draw air, thereby, the first heat generating component is cooled via the first and second fans 8, 30. Airflow created by the first and second fans 8, 30 flows through the through passage 12 of the air-guiding unit 6 to assist dissipation of heat from the second heat generating component. The air conducting device is adjustable to ensure at least two heat generating components receive cooling airflow even when configuration of the components is changed.

In another embodiment, the second fan 30 can be omitted. The first fan 8 draws air to cool the first heat generating component, and then, airflow created by the first fan 8 flows along the fixing portion 10 and the conducting member 20 of the air-guiding unit 6 to assist in dissipation heat of the second heat generating component. Therefore, the elastic fixing hooks 262 of the conducting member 20 of the air-guiding unit 6, and the supporting surface 264 of the conducting member 20 can also be omitted.

It is believed that the present embodiments and their advantages will be understood from the foregoing description, and they will be apparent that various changes may be made thereto without departing from the spirit and scope of the description or sacrificing all of its material advantages, the examples hereinbefore described merely being exemplary embodiments.

What is claimed is:

1. An air conducting device comprising:
an air-guiding unit comprising a fixing member and a conducting member slidably mounted to the fixing member, the fixing member defining a plurality of slots arranged in a line, and a through passage, the conducting member defining a through hole communicating with the through passage, a locking protrusion protruding from the conducting member, wherein the locking protrusion is adjustably engaged in one of the plurality of slots; and
a first fan fixed in the through passage of the fixing member, opposite to the conducting member.

2. The air conducting device of claim 1, wherein the fixing member comprises a larger receiving portion and a smaller locking portion extending from the receiving portion, the through passage longitudinally extends through the receiving portion and the locking portion, the conducting member comprises a connecting member slidably mounted to the locking portion, adjacent to the locking portion.

3. The air conducting device of claim 2, wherein opposite sidewalls bounding the through hole each define a sliding rail, two sliding blocks protrude from opposite sidewalls of the locking portion, to engage in the sliding rails correspondingly.

4. The air conducting device of claim 2, wherein the plurality of slots are defined in a top sidewall of the locking portion, a latching portion extends from a top sidewall of the connecting portion, and the locking protrusion protrudes from the latching portion.

5. The air conducting device of claim 2, wherein a top sidewall of the receiving portion defines an opening communicating with the through passage, the first fan is placed in the through passage through the opening.

6. The air conducting device of claim 5, wherein the through passage is stepped, with a circular stopping surface formed on an inner sidewall bounding the through passage, at a joint of the receiving portion and the locking portion; four fixing blocks extend inwards the through passage, from corners of the receiving portion, away from the stopping surface, opposite sides of the first fan resist against the fixing blocks and the stopping surface.

7. The air conducting device of claim 6, further comprising four fasteners, wherein each fastener comprises a head portion, a tapered engaging portion, and a neck portion connected the head portion and the engaging portion, each fixing block defines a mounting hole, and the first fan defines four through holes, the engaging portions are urged to extend through the mounting holes and the through holes of the fan in that order, to fix the fan to the fixing member.

8. The air conducting device of claim 7, wherein each fastener is made of elastic material, the engaging portion of each fastener defines a cutout for deforming the engaging portion.

9. The air conducting device of claim 2, further comprising a second fan, wherein the conducting member is substantially L-shaped and further comprises a guiding portion slantingly connected to the connecting portion, the through hole extends through the connecting portion and the guiding portion, the second fan is accommodated in the through hole and located at the guiding portion.

10. The air conducting device of claim 9, wherein a stepped supporting surface is formed on an inner sidewall bounding the through hole at the guiding portion, four elastic fixing hooks extend from distal ends of the guiding portion, opposite sides of the second fan resist against the supporting surface and the fixing hooks.

11. An air-guiding unit comprising:
a fixing member defining a plurality of slots arranged in a line, and a through passage; and
a conducting member slidably mounted to the fixing member, the conducting member defining a through hole communicating with the through passage, a locking protrusion protruding from the conducting member, wherein the locking protrusion is adjustably engaged in one of the plurality of slots.

12. The air-guiding unit of claim 11, wherein the fixing member comprises a larger receiving portion and a smaller locking portion extending from the receiving portion, the through passage longitudinally extends through the receiving portion and the locking portion, the conducting member comprises a connecting member slidably mounted to the locking portion.

13. The air-guiding unit claim 12, wherein opposite sidewalls bounding the through hole each define a sliding rail, two sliding blocks protrude from opposite sidewalls of the locking portion, to engage in the sliding rails correspondingly.

14. The air-guiding unit of claim 12, wherein the plurality of slots are defined in a top sidewall of the locking portion, a latching portion extends from a top sidewall of the connecting portion, and the locking protrusion protrudes from the latching portion.

15. The air-guiding unit of claim 12, wherein two hooks extend from a top sidewall of the receiving portion, opposite to locking portion, a tab extends downward from a bottom sidewall of the receiving portion, the hooks and the tab assist for fixing the receiving portion.
